(19) United States
(12) Patent Application Publication
(10) Pub. No.: US 2014/0365660 A1
(43) Pub. Date: Dec. 11, 2014

(54) Systems and Methods for Accessing Network Data

(71) Applicant: Tencent Technology (Shenzhen) Company Limited, Shenzhen (CN)

(72) Inventor: Dong Wang, Shenzhen (CN)

(73) Assignee: Tencent Technology (Shenzhen) Company Limited, Shenzhen (CN)

(21) Appl. No.: 14/161,777

(22) Filed: Jan. 23, 2014

Related U.S. Application Data
(63) Continuation of application No. PCT/CN2013/086564, filed on Nov. 5, 2013.

(30) Foreign Application Priority Data
Apr. 16, 2013 (CN) 201310131411.X

(51) Int. Cl. H04L 29/08

(52) U.S. Cl. CPC H04L 67/1014
USPC 709/226

(57) ABSTRACT

Systems and methods are provided for accessing network data. For example, a network-data-access request associated with one or more web-page applications sent through a browser by a user is intercepted; information associated with global server-load balance is acquired; an access server matching with the network-data-access request is selected based on at least information associated with the global server load balance; the network-data-access request is redirected to the access server; and network data is accessed through the access server.

### CROSS-REFERENCES TO RELATED APPLICATIONS

This application claims priority to Chinese Patent Application No. 201310131411.X, filed Apr. 16, 2013, incorporated by reference herein for all purposes.

### BACKGROUND OF THE INVENTION

Certain embodiments of the present invention are directed to computer technology. More particularly, some embodiments of the invention provide systems and methods for data processing. Merely by way of example, some embodiments of the invention have been applied to network data. But it would be recognized that the invention has a much broader range of applicability.

Currently, when a browser accesses network data in certain web-page applications (e.g., accessing network resources or requesting a network for logical processing), a direct-connection mode is generally adopted. For example, Hypertext Transfer Protocol (HTTP) and Socket are used to communicate directly with a server, such as a logical server or a resource server. Network data is accessed through a HTTP request. As an example, a logical server is requested for logical processing or a resource server is requested for resource access.

The above-noted conventional technology has some disadvantages. For example, the existing network environment is often complex, involving multiple network operators and multiple cities. The direct-connection mode usually causes slow responses for user access of network data or even disconnection during access, which results in poor network-data-access quality, thus seriously affecting the reliability and fluency of the network data access.

Hence it is highly desirable to improve the techniques for accessing network data.

### BRIEF SUMMARY OF THE INVENTION

According to one embodiment, a method is provided for accessing network data. For example, a network-data-access request associated with one or more web-page applications sent through a browser by a user is intercepted; information associated with global server-load balance is acquired; an access server matching with the network-data-access request is selected based on at least information associated with the global server load balance; the network-data-access request is redirected to the access server; and network data is accessed through the access server.

According to another embodiment, a device for accessing network data includes an intercepting unit, an acquisition unit, a selection unit, a redirecting unit, and an accessing unit. The intercepting unit is configured to intercept a network-data-access request associated with one or more web-page applications sent through a browser by a user. The acquisition unit is configured to acquire information associated with global server-load balance. The selection unit is configured to select an access server matching with the network-data-access request based on at least information associated with the global server load balance. The redirecting unit is configured to redirect the network-data-access request to the access server. The accessing unit is configured to access network data through the access server.

According to yet another embodiment, a non-transitory computer readable storage medium comprises programming instructions for accessing network data. The programming instructions are configured to cause one or more data processors to execute certain operations. For example, a network-data-access request associated with one or more web-page applications sent through a browser by a user is intercepted; information associated with global server-load balance is acquired; an access server matching with the network-data-access request is selected based on at least information associated with the global server load balance; the network-data-access request is redirected to the access server; and network data is accessed through the access server.

For example, the systems and methods described herein are configured to improve the quality of network-data access associated with one or more web-page applications and also the reliability and fluency of network-data access.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for accessing network data in web-page applications according to one embodiment of the present invention.

FIG. 2 is a simplified diagram showing a method for accessing network data in web-page applications according to another embodiment of the present invention.

FIG. 3 is a simplified diagram showing a method for accessing network data in web-page applications according to yet another embodiment of the present invention.

FIG. 4 is a simplified diagram showing a device for accessing network data in web-page applications according to one embodiment of the present invention.

FIG. 5 is a simplified diagram showing a terminal for accessing network data according to some embodiments of the present invention.

### DETAILED DESCRIPTION OF THE INVENTION

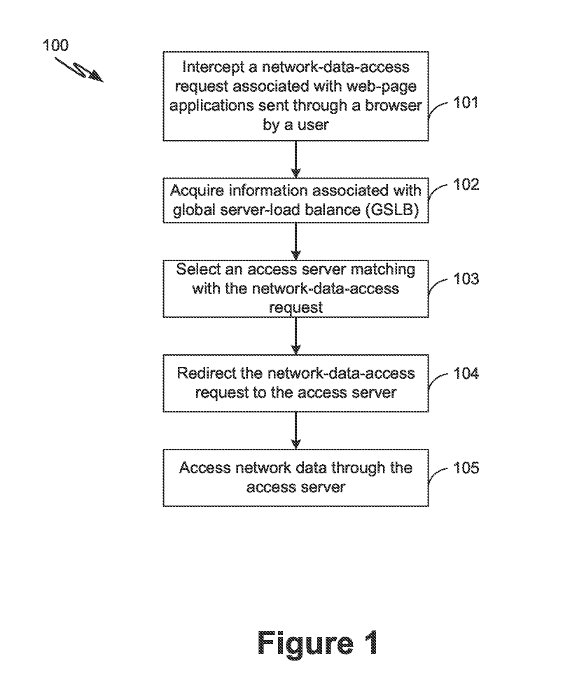

FIG. 1 is a simplified diagram showing a method for accessing network data in web-page applications according to one embodiment of the present invention. This diagram is merely an example, which should not unduly limit the scope of the claims. One of ordinary skill in the art would recognize many variations, alternatives, and modifications. The method 100 includes at least the process 101 for intercepting a network-data-access request associated with one or more web-page applications sent through a browser by a user, the process 102 for acquiring information associated with global server-load balance, the process 103 for selecting an access server matching with the network-data-access request, the process 104 for redirecting the network-data-access request to the access server, and the process 105 for accessing network data through the access server.

According to one embodiment, during the process 101, a network-data-access request associated with one or more web-page applications sent through a browser by a user is intercepted. For example, the network-data-access request associated with the web-page applications sent through a browser by a user is intercepted through a browser proxy device. In another example, the network-data-access request associated with the web-page applications sent through a browser by a user is intercepted through a HOOK function which corresponds to a Microsoft Windows platform for message processing. As an example, an application sets up a sub-program through the HOOK function for monitoring a certain type of messages in designated windows created by one or more other processes. When a message arrives, the message is processed before a target window processes a related function, in some embodiments. For example, the HOOK mechanism allows an application to intercept and process a Windows message or a specified event In another example, a request for accessing network data includes several types of messages, e.g., a logical request, and/or a resource request. In yet another example, the request for accessing network data is represented in many forms, e.g. a request sent via HTTP, or a request sent via Socket. As an example, the one or more web-page applications include a web-page game, and/or a web-page video.

According to another embodiment, during the process 102, information associated with global server-load balance (GSLB) is acquired. For example, GSLB is mainly used for realize traffic deployment among servers in different regions on a Wide-Area-Network (WAN) including the Internet and ensure that a best server is used to serve nearest customers, so as to improve network-access quality. As an example, information associated with GSLB refers to the information reflecting the current GSLB condition. For example, the GSLB information is acquired according to a user Internet-Protocol (IP) and an operator condition.

According to yet another embodiment, during the process 103, an access server matching with the network-data-access request intercepted in the process 101 is selected based on at least information associated with GSLB acquired in the process 102. For example, a currently most-suitable access server is selected, e.g. a nearest access server with the least load. In another example, during the process 104, the network-data-access request is redirected to the access server selected in the process 104. In yet another example, during the process 105, the network data is accessed through the access server. For example, different network-data accesses are made via the access server in response to different network-data-access requests, as follows:
(1) If the network-data-access request is a logical request, the process 105 includes: requesting logical processing from a logical server through the access server. For example, when the logical server receives the logical request, the logic server carries out logical processing according to the logical request and obtains the logical processing results. As an example, the logical processing request is returned to the browser, and the process 105 also includes: receiving logical-processing results from the logical server through the access server.
(2) If the network-data-access request is a resource request, the process 105 includes: requesting resources from a resource server through the access server. For example, when the resource server receives the resource request, the resource server distributes resources according to the resource request, and the process 105 further includes: receiving the resources from the resource server through the access server.

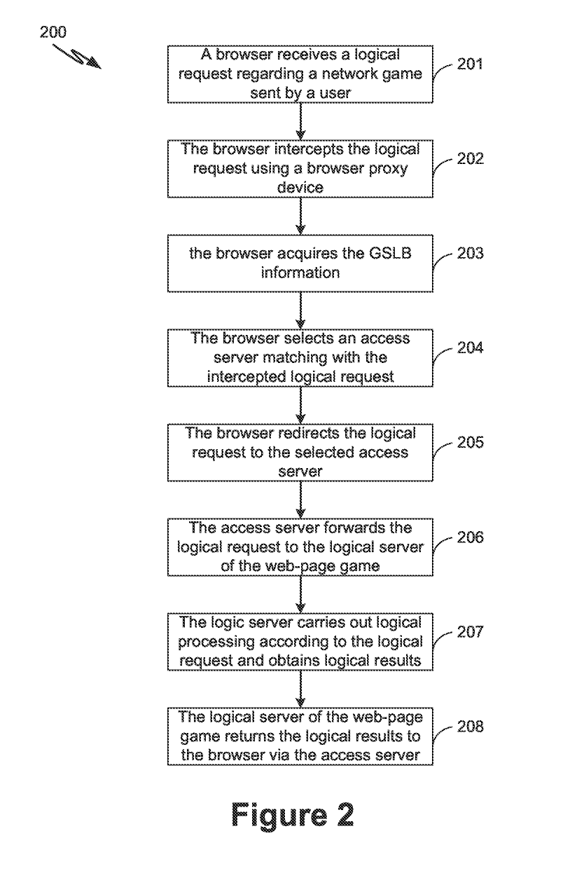

FIG. 2 is a simplified diagram showing a method for accessing network data in web-page applications according to another embodiment of the present invention. This diagram is merely an example, which should not unduly limit the scope of the claims. One of ordinary skill in the art would recognize many variations, alternatives, and modifications. The method 200 includes at least the processes 201-208.

According to one embodiment, a web-page application is specifically a web-page game, and a device for accessing network data is integrated into a client device which corresponds to a browser. For example, during the process 201, the browser receives a logical request regarding a network game sent by a user. In another example, the logical request regarding the network game is represented in many forms, such as a request issued via HTTP or a request sent via Socket. In yet another example, during the process 202, the browser intercepts the logical request using a browser proxy device. In yet another example, during the process 203, the browser acquires the GSLB information. For example, the GSLB information is acquired according to a user IP and an operator condition.

According to another embodiment, during the process 204, the browser selects an access server matching with the intercepted logical request. For example, a currently most-suitable access server is selected, e.g. a nearest access server with the least load. For example, during the process 205, the browser redirects the logical request to the selected access server. In another example, during the process 206, the access server, as a transit proxy, forwards the logical request to the logical server of the web-page game. In yet another example, during the process 207, when the logical server of the web-page game receives the logical request, the logic server carries out logical processing according to the logical request and obtains logical results. In yet another example, during the process 208, the logical server of the web-page game returns the logical results to the browser via the access server to be displayed to the user.

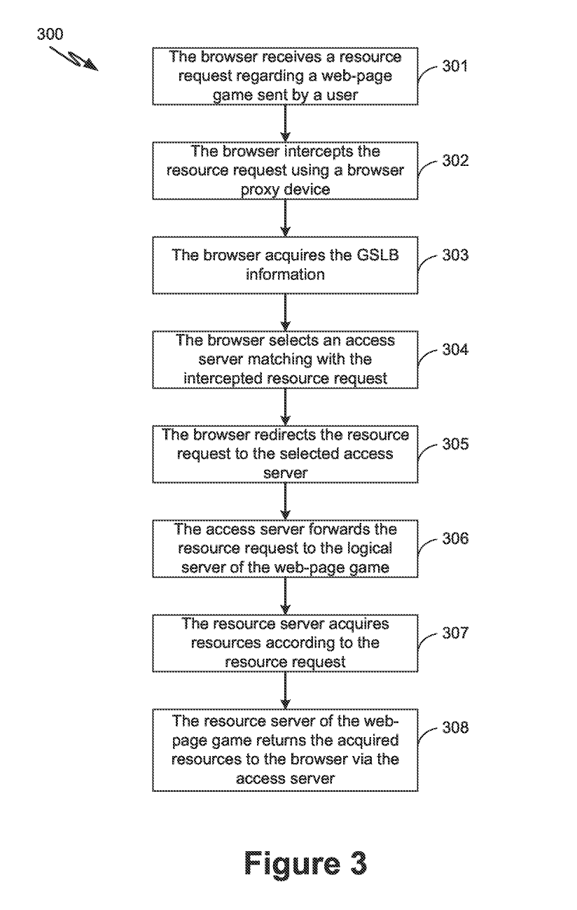

FIG. 3 is a simplified diagram showing a method for accessing network data in web-page applications according to yet another embodiment of the present invention. This diagram is merely an example, which should not unduly limit the scope of the claims. One of ordinary skill in the art would recognize many variations, alternatives, and modifications. The method 300 includes at least the processes 301-308.

According to one embodiment, a web-page application is a web-page game application, and a device for accessing network data is integrated into a client device which corresponds to a browser. For example, during the process 301, the browser receives a resource request regarding a web-page game sent by a user. As an example, the resource request regarding a web-page game is represented in many forms, such as a request issued via HTTP or a request sent via Socket. As another example, during the process 302, the browser intercepts the resource request using a browser proxy device. As yet another example, during the process 303, the browser acquires the GSLB information. For example, the GSLB information is acquired according to a user IP and an operator condition.

According to another embodiment, during the process 304, the browser selects an access server matching with the intercepted resource request. For example, a currently most-suitable access server is selected, e.g. a nearest access server with the least load. In another example, during the process 305, the browser redirects the resource request to the selected access server. In yet another example, during the process 306, the access server, as a transit proxy, forwards the resource request to the logical server of the web-page game. In yet another example, during the process 307, when the resource server of the web-page game receives the resource request, the resource server acquires resources according to the resource request. In yet another example, during the process 308, the resource server of the web-page game returns the acquired resources to the browser via the access server to be displayed to the user.

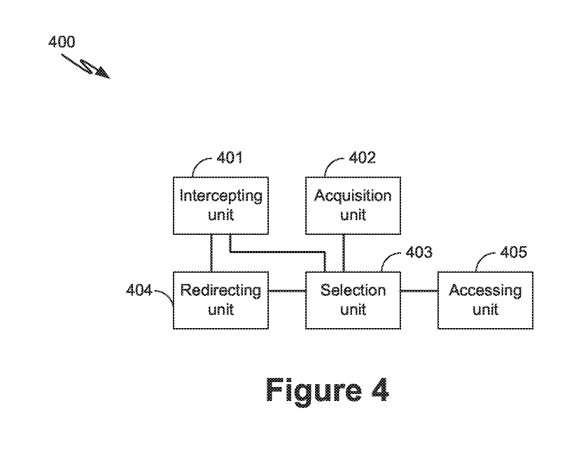

FIG. 4 is a simplified diagram showing a device for accessing network data in web-page applications according to one embodiment of the present invention. This diagram is merely an example, which should not unduly limit the scope of the claims. One of ordinary skill in the art would recognize many variations, alternatives, and modifications. The device 400 includes an intercepting unit 401, an acquisition unit 402, a selection unit 403, a redirecting unit 404 and an accessing unit 405.

According to one embodiment, the intercepting unit 401 is configured to intercept a network-data-access request associated with one or more web-page applications sent through a browser by a user. For example, the acquisition unit 402 is configured to acquire information associated with global server-load balance (GSLB). As an example, GSLB is mainly used for realize traffic deployment among servers in different regions on a Wide-Area-Network (WAN) including e Internet and ensure that a best server is used to serve nearest customers, so as to improve network-access quality. As another example, information associated with GSLB refers to the information reflecting the current GSLB condition. For example, the GSLB information is acquired according to a user Internet-Protocol (IP) and an operator condition.

According another embodiment, the selection unit 403 is configured to select an access server matching with the network-data-access request based on at least information associated with GSLB acquired by the acquisition unit 402. For example, a currently most-suitable access server is selected, e.g. a nearest access server with the least load. In another example, the redirecting unit 404 is configured to redirect the network-data-access request to the access server. In yet another example, the accessing unit 405 is configured to access network data through the access server. For example, the intercepting unit 401 is further configured to intercept the network-data-access request associated with the web-page applications sent through the browser by the user through a browser proxy device. In another example, the intercepting unit 401 is further configured to intercept the network-data-access request associated with the web-page applications sent through the browser by the user through a HOOK function. In another example, the request for accessing network data includes several types of messages, e.g., a logical request, and/or a resource request.

According to yet another embodiment, if the network-data-access request is a logical request, the accessing unit 405 is further configured to request logical processing from a logical server through the access server and receive logical-processing results from the logical server through the access server. For example, if the network-data-access request is a resource request, the accessing unit 405 is further configured to request resources from a resource server through the access server and receive the resources from the resource server through the access server. In certain embodiments, different units of the device 400 are realized as independent components, or realized in various combinations as a single component or multiple components. In some embodiments, the device 400 is integrated into a client device which is installed on a terminal, and the terminal includes a smart mobile phone, a tablet PC, an e-book reader, an MP3 player, an MP4 player, a laptop portable computer, a desktop computer, or other suitable electronic devices.

In certain embodiments, a communication system includes the device 400 which is integrated into a client device. For example, the client device intercepts a network-data-access request associated with one or more web-page applications sent through a browser by a user, acquires information associated with global server-load balance, selects an access server matching with the network-data-access request based on at least information associated with the global server load balance, redirects the network-data-access request to the access server, and accesses network data through the access server. In another example, the client device intercepts, using a browser proxy device, the network-data-access request associated with the web-page applications sent through the browser by the user, or intercepts, using a HOOK function, the network-data-access request associated with the web-page applications sent through the browser by the user. As an example, a request for accessing network data includes several types of messages, e.g. logical requests, resource requests, etc. As another example, the request for accessing network data is represented in many forms, e.g. a request sent via HTTP or a request sent via Socket. In some embodiments, the communication system includes an access server and a server device corresponding to the client device. For example, the access server is configured to receive the selection of the client device and act as a transit proxy between the client device and the server device. As an example, the access server receives the request for accessing network data regarding one or more web-page applications sent by the client device and forwards the request for accessing network data to the server device. As another example, the access server also receives data processing results issued by the server device and returns the data processing results to the client device. In another example, the server device is configured to receive the request for accessing network data forwarded by the access server, process the data according to the request for accessing network data (e.g. logical processing or resource acquisition) to obtain the data processing results (e.g. obtain logical processing result or resources) and return the data processing results to the client device via the access server. In yet another example, the server device includes a logical server or a resource server.

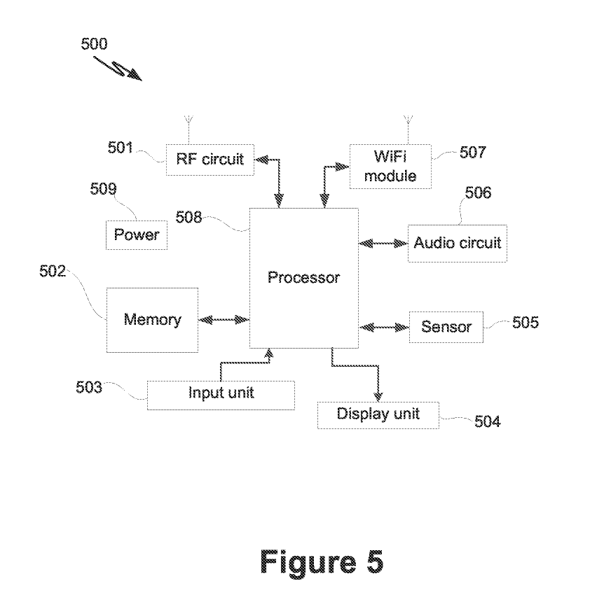

FIG. 5 is a simplified diagram showing a terminal for accessing network data according to some embodiments of the present invention. This diagram is merely an example, which should not unduly limit the scope of the claims. One of ordinary skill in the art would recognize many variations, alternatives, and modifications. The terminal 500 is used to execute the methods as shown in FIG. 1, FIG. 2 and/or FIG. 3.

According to one embodiment, the terminal 500 includes a RF circuit 501, a memory 502 that includes one or more computer-readable storage medium, an input unit 503, a display unit 504, a sensor 505, an audio circuit 506, a WiFi (e.g., wireless fidelity) module 507, one or more processors 508 that includes one or more processing cores, and a power supply 509. For example, the RF circuit 501 is configured to send/receive messages or signals in communication. As an example, the RF circuit 501 receives a base station's downlink information, delivers to the processors 508 for processing, and sends uplink data to the base station. For example, the RF circuit 501 includes an antenna, at least one amplifier, a tuner, one or several oscillators, SIM (Subscriber Identity Module) card, a transceiver, a coupler, an LNA (Low Noise Amplifier) and a duplexer. In another example, the RF circuit 501 communicates with the network and other equipments via wireless communication based on any communication standard or protocols, such as GSM (Global System of Mobile communication), GPRS (General Packet Radio Service), CDMA (Code Division Multiple Access), WCDMA (Wideband Code Division Multiple Access), LTE (Long Term Evolution), email, SMS (Short Messaging Service), etc.

According to another embodiment, the memory 502 is configured to store software programs and modules. For example, the processors 508 are configured to execute various functional applications and data processing by running the software programs and modules stored in the memory 502. The memory 502 includes a program storage area and a data storage area, where the program storage area may store the operating system, and the application(s) required by one or more functions (e.g., an audio player or a video player), in some embodiments. For example, the data storage area stores the data created based on the use of the terminal 500 (e.g., audio data or a phone book). In another example, the memory 502 includes a high-speed random access storage, a non-volatile memory, one or more floppy disc storage devices, a flash storage device or other volatile solid storage devices. As an example, the memory 502 further includes a memory controller to enable access to the memory 502 by the processors 508 and the input unit 503.

According to yet another embodiment, the input unit 503 is configured to receive an input number or character data and generate inputs for a keyboard, a mouse, and a joystick, optical or track signals relating to user setting and functional control. For example, the input unit 503 includes a touch-sensitive surface and other input devices. The touch-sensitive surface (e.g., a touch screen or a touch panel) is configured to receive the user's touch operations thereon or nearby (e.g., the user's operations on or near the touch-sensitive surface with a finger, a touch pen or any other appropriate object or attachment) and drive the corresponding connected devices according to the predetermined program. For example, the touch-sensitive surface includes two parts, namely a touch detector and a touch controller. The touch detector detects the position of user touch and the signals arising from such touches and sends the signals to the touch controller. The touch controller receives touch data from the touch detector, converts the touch data into the coordinates of the touch point, sends the coordinates to the processors 508 and receives and executes the commands received from the processors 508. For example, the touch-sensitive surface is of a resistance type, a capacitance type, an infrared type and a surface acoustic wave type. In another example, other than the touch-sensitive surface, the input unit 503 includes the other input devices. For example, the other input devices include one or more physical keyboards, one or more functional keys (e.g., volume control keys or switch keys), a track ball, a mouse and/or a joystick.

According to yet another embodiment, the display unit 504 is configured to display data input from a user or provided to the user, and includes various graphical user interfaces of the terminal 500. For example, these graphical user interfaces include graphs, texts, icons, videos and a combination thereof. The display unit 504 includes a display panel which contains a LCD (liquid crystal display), an OLED (organic light-emitting diode). As an example, the touch-sensitive surface can cover the display panel. For example, upon detecting any touch operations thereon or nearby, the touch-sensitive surface sends signals to the processors 508 to determine the type of the touch events and then the processors 508 provides corresponding visual outputs on the display panel according to the type of the touch events. Although the touch-sensitive surface and the display panel are two independent parts for input and output respectively, the touch-sensitive surface and the display panel can be integrated for input and output, in some embodiments.

In one embodiment, the terminal 500 includes a sensor 505 (e.g., an optical sensor, a motion sensor or other sensors). For example, the sensor 505 includes an environment optical sensor and adjusts the brightness of the display panel according to the environmental luminance. In another example, the sensor 505 includes a proximity sensor and turns off or backlights the display panel when the terminal 500 moves close to an ear of a user. In yet another example, the sensor 505 includes a motion sensor (e.g., a gravity acceleration sensor) and detects a magnitude of acceleration in all directions (e.g., three axes). Particularly, the sensor 505 detects magnitude and a direction of gravity when staying still. In some embodiments, the sensor 505 is used for identifying movements of a cell phone (e.g., a switch of screen direction between horizontal and vertical, related games, and a calibration related to a magnetometer) and features related to vibration identification (e.g., a pedometer or a strike). In certain embodiments, the sensor 505 includes a gyroscope, a barometer, a hygroscope, a thermometer and/or an infrared sensor.

In another embodiment, the audio circuit 506, a speaker, and a microphone are configured to provide an audio interface between a user and the terminal 500. For example, the audio circuit 506 is configured to transmit electrical signals converted from certain audio data to the speaker that converts such electrical signals into some output audio signals. In another example, the microphone is configured to convert audio signals into electrical signals which are converted into audio data by the audio circuit 506. The audio data are processed in the processors 508 and received by the RF circuit 501 before being sent to another terminal, in some embodiments. For example, the audio data are output to the memory 502 for further processing. As an example, the audio circuit 506 includes an earphone jack for communication between a peripheral earphone and the terminal 500.

WiFi is a short-distance wireless transmission technology. In some embodiments, through the WiFi module 507, the terminal 500 enables the user to receive and send emails, browse webpages, and/or access stream media. For example, the terminal 500 is configured to provide the user with a wireless broadband Internet access. In some embodiments, the WiFi module 507 is omitted in the terminal 500.

According to one embodiment, the processors 508 are the control center of the terminal 500. For example, the processors 508 is connected to various parts of the terminal 500 (e.g., a cell phone) via various interfaces and circuits, and executes various features of the terminal 500 and processes various data through operating or executing the software programs and/or modules stored in the memory 502 and calling the data stored in the memory 502, so as to monitor and control the terminal 500 (e.g., a cell phone). As an example, the processors 508 include one or more processing cores. In another example, the processors 508 is integrated with an application processor and a modem processor, where the application processor mainly handles the operating system, the user interface and the applications and the modem processor mainly handles wireless communications. In some embodiments, the modem processor is not integrated into the processors 508.

According to another embodiment, the terminal 500 includes the power supply 509 (e.g., a battery) that powers up various parts. For example, the power supply 509 is logically connected to the processors 508 via a power source management system so that the charging, discharging and power consumption can be managed via the power source management system. In another example, the power supply 509 includes one or more DC or AC power sources, a recharging system, a power-failure-detection circuit, a power convener, an inverter, a power source state indicator, or other components. In yet another example, the terminal 500 includes a camcorder, a Bluetooth module, etc. Specifically, the processors 508 of the terminal 500 load executable files associated with one or more applications to the memory 502 and run the applications stored in the memory 502 according to the method 100, the method 200, and/or the method 300.

According to one embodiment, a method is provided for accessing network data. For example, a network-data-access request associated with one or more web-page applications sent through a browser by a user is intercepted; information associated with global server-load balance is acquired; an access server matching with the network-data-access request is selected based on at least information associated with the global server load balance; the network-data-access request is redirected to the access server; and network data is accessed through the access server. For example, the method is implemented according to at least FIG. 1, FIG. 2, and/or FIG. 3.

According to another embodiment, a device for accessing network data includes an intercepting unit, an acquisition unit, a selection unit, a redirecting unit, and an accessing unit. The intercepting unit is configured to intercept a network-data-access request associated with one or more web-page applications sent through a browser by a user. The acquisition unit is configured to acquire information associated with global server-load balance. The selection unit is configured to select an access server matching with the network-data-access request based on at least information associated with the global server load balance. The redirecting unit is configured to redirect the network-data-access request to the access server. The accessing unit is configured to access network data through the access server. For example, the device is implemented according to at least FIG. 4, and/or FIG. 5.

According to yet another embodiment, a non-transitory computer readable storage medium comprises programming instructions for accessing network data. The programming instructions are configured to cause one or more data processors to execute certain operations. For example, a network-data-access request associated with one or more web-page applications sent through a browser by a user is intercepted; information associated with global server-load balance is acquired; an access server matching with the network-data-access request is selected based on at least information associated with the global server load balance; the network-data-access request is redirected to the access server; and network data is accessed through the access server. For example, the storage medium is implemented according to at least FIG. 1, FIG. 2, and/or FIG. 3.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for accessing network data, the method comprising:
intercepting a network-data-access request associated with one or more webpage applications sent through a browser by a user;
acquiring information associated with global server-load balance;
selecting an access server matching with the network-data-access request based on at least information associated with the global server load balance;
redirecting the network-data-access request to the access server; and
accessing network data through the access server.

2. The method of claim 1, wherein the intercepting a network-data-access request associated with one or more web-page applications sent through a browser by a user includes:
intercepting, using a browser proxy device, the network-data-access request associated with the web-page applications sent through the browser by the user.

3. The method of claim 1, wherein the intercepting a network-data-access request associated with one or more web-page applications sent through a browser by a user includes:
intercepting, using a HOOK function, the network-data-access request associated with the web-page applications sent through the browser by the user.

4. The method of claim 1, wherein:
the network-data-access request corresponds to a logical request; and
the accessing network data using the access server includes:
requesting logical processing from a logical server through the access server.

5. The method of claim 4, wherein the accessing network data using the access server includes:
receiving logical-processing results from the logical server through the access server.

6. The method of claim 1, wherein:
the network-data-access request corresponds to a resource request; and
the accessing network data using the access server includes:
requesting resources from a resource server through the access server.

7. The method of claim 6, wherein the accessing network data using the access server includes:
receiving the resources from the resource server through the access server.

8. A device for accessing network data, the device comprising:
an intercepting unit configured to intercept a network-data-access request associated with one or more web-page applications sent through a browser by a user;
an acquisition unit configured to acquire information associated with global server-load balance;
a selection unit configured to select an access server matching with the network-data-access request based on at least information associated with the global server load balance;
a redirecting unit configured to redirect the network-data-access request to the access server; and
an accessing unit configured to access network data through the access server.

9. The device of claim 7, wherein:
the intercepting unit is further configured to intercept, using a browser proxy device, the network-data-access request associated with the web-page applications sent through the browser by the user; and
the intercepting unit is further configured to intercept, using a HOOK function, the network-data-access request associated with the web-page applications sent through the browser by the user.

10. The device of claim 8, wherein:
the network-data-access request corresponds to a logical request; and
the accessing unit is further configured to:
request logical processing from a logical server through the access server; and
receive logical-processing results from the logical server through the access server.

11. The device of claim 10, wherein:
the network-data-access request corresponds to a resource request; and
the accessing unit is further configured to:
request resources from a resource server through the access server; and
receive the resources from the resource server through the access server.

12. The device of claim 8, further comprising:
one or more data processors; and
a computer-readable storage medium;
wherein one or more of the intercepting unit, the acquisition unit, the selection unit, the redirecting unit, and the accessing unit are stored in the storage medium and configured to be executed by the one or more data processors.

13. A communication system, comprising the device for accessing network data as in claim 8.

14. (canceled)
